(19) United States
(12) Patent Application Publication
(10) Pub. No.: US 2013/0151100 A1
(43) Pub. Date: Jun. 13, 2013

(54) ACTUATOR COMPENSATION SYSTEM FOR CLUTCH AND METHOD THEREOF

(71) Applicants: Hyundai Motor Company, Seoul (KR); Keyang Electric Machinery Co., Ltd., Seoul (KR); Motonic Corporation, Seoul (KR)

(72) Inventors: Hee Ra LEE, Anyang-si (KR); Baekyu Kim, Suwon-si (KR); Yeonho Kim, Suwon-si (KR); Myung-Kweon Kang, Daegu (KR); Wookyo Jang, Hwaseong-si (KR); Jungchul Kim, Cheonan-si (KR); Namhun Lee, Pyeongtaek-si (KR); Junglyung Choi, Daegu (KR); Hyoungsu Kim, Daegu (KR)

(73) Assignees: Hyundai Motor Company, Seoul (KR); Motonic Corporation, Seoul (KR); Keyang Electric Machinery Co., Ltd., Seoul (KR)

(21) Appl. No.: 13/693,960

(22) Filed: Dec. 4, 2012

(30) Foreign Application Priority Data
Dec. 9, 2011 (KR) 10-2011-0132253

(51) Int. Cl. F16D 28/00

(52) U.S. Cl. CPC F16D 28/00
USPC 701/68; 192/84.6

(57) ABSTRACT

A compensation method of an actuator system for a clutch may compensate initial operating position of an actuator that may be changed due to abrasion so that may maintain stroke distance of a clutch stable. The compensation method includes determining a target pressure if operating requirement of a clutch is detected and operating an actuator according to the target pressure, determining whether operating movement of the actuator is strayed from a predetermined value if operating pressure of the actuator reaches the target pressure, determining error of initial operating position of the actuator if the operating movement of the actuator is strayed from the predetermined value and determining compensating ratio according to the detected position deviation of the error and compensates the initial operating position of the actuator by controlling a lead screw of the actuator according to the determined compensating ratio.

### CROSS-REFERENCE TO RELATED APPLICATION

The present application claims priority of Korean Patent Application Number 10-2011-0132253 filed Dec. 9, 2011, the entire contents of which application is incorporated herein for all purposes by this reference.

### BACKGROUND OF INVENTION

1. Field of Invention

The present invention relates to an actuator for a clutch. More particularly, the present invention relates to an actuator compensation system for a clutch and a method thereof which may compensate initial operating position of an actuator which may be changed due to abrasion so that may maintain stroke distance of a clutch stable.

2. Description of Related Art

A dual-clutch transmission, (DCT) (sometimes referred to as a twin-clutch gearbox or double-clutch transmission), is a type of semi-automatic or automated manual automotive transmission. It uses two separate clutches for odd and even gear sets. It can fundamentally be described as two separate manual transmissions (with their respective clutches) contained within one housing, and working as one unit

They are usually operated in a fully automatic mode, and many also have the ability to allow the driver to manually shift gears, albeit still carried out by the transmission's electro-hydraulics.

In DCTs where the two clutches are arranged concentrically, the larger outer clutch drives the odd numbered gears, whilst the smaller inner clutch drives the even numbered gears.

Shifts can be accomplished without interrupting torque distribution to the driven road wheels, by applying the engine's torque to one clutch at the same time as it is being disconnected from the other clutch.

Since alternate gear ratios can pre-select an odd gear on one gear shaft whilst the vehicle is being driven in an even gear, (and vice versa), DCTs are able to shift more quickly than cars equipped with single-clutch automated-manual transmissions (AMTs), a.k.a. single-clutch semi-automatics.

Also, with a DCT, shifts can be made more smoothly than with a single-clutch AMT, making a DCT more suitable for conventional road cars.

In a dual clutch transmission, alternate gear ratios can pre-select an odd gear on one gear shaft whilst the vehicle is being driven in an even gear by means of an electric actuator.

However, a disk of a dry clutch applied to the clutch transmission may be worn out and spring constant of a diaphragm may be reduced according to long-term use.

And thus, if an actuator drives a clutch at a constant stroke, complete disengagement of a clutch may not be expected due to wearing out of a disk and reduction of spring constant of a diaphragm.

So, it is a problem that stable engagement and release of gears may not be expected.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for an actuator compensation system for a clutch and a method thereof which may compensate initial operating position of an actuator that may be changed due to abrasion so that the system and the method may maintain stroke distance of a clutch stable and provide stable and reliable operation.

Various aspects of the present invention provide for actuator compensation system for a clutch that may include a motor, an actuator connected with the motor and operating a clutch and a control portion which operates the motor at a predetermined pressure according to requirement of operation of the clutch so as that the motor operates the clutch, and compensates initial operating position of the actuator if operating movement of the actuator is changed from a predetermined value.

The actuator may include a lead screw connected with the motor, a moving body gear coupled to the lead screw and a rod of which one end is connected with the moving body and the other end is connected with a pedal of the clutch.

The control portion may determine that position deviation of the actuator is occurred due to abrasion of a disk of the clutch if operating movement of the actuator is strayed from the predetermined value, determine compensating ratio, and compensate the initial operating position of the actuator by controlling the lead screw of the actuator according to the determined compensating ratio.

Various aspects of the present invention provide for a compensation method of an actuator system for a clutch that may include determining a target pressure if operating requirement of a clutch is detected and operating an actuator according to the target pressure, determining whether operating movement of the actuator is strayed from a predetermined value if operating pressure of the actuator reaches the target pressure, determining error of initial operating position of the actuator if the operating movement of the actuator is strayed from the predetermined value and determining compensating ratio according to the detected position deviation of the error and compensates the initial operating position of the actuator by controlling a lead screw of the actuator according to the determined compensating ratio.

An actuator compensation system for a clutch and a compensation method of an actuator system for a clutch may compensate initial operating position of an actuator that may be changed due to abrasion so that the system and the method may maintain stroke distance of a clutch stable is disclosed.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a drawing showing an exemplary actuator compensation system for a clutch according to the present invention.

FIG. 2 is a flow chart of an exemplary compensation method of an actuator system for a clutch according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Description of components that are not necessary for explaining the present invention will be omitted, and the same constituent elements are denoted by the same reference numerals in this specification.

In addition, size and thickness of components shown in the drawings may be differ from real size and real thickness of the components for better comprehension and ease of description. Therefore, the present invention is not limited to those shown in the drawings.

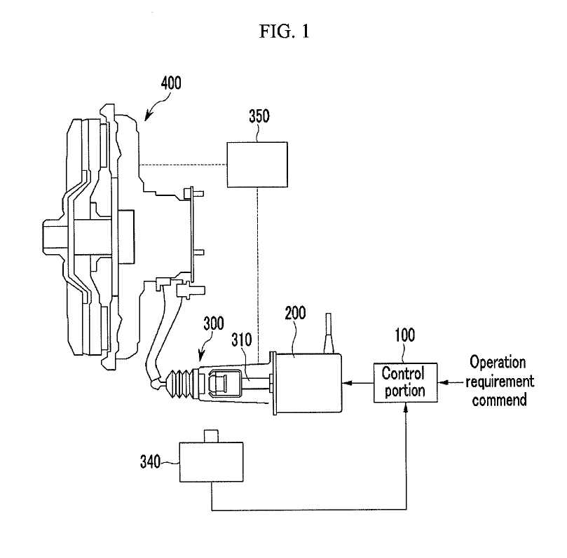

FIG. 1 is a drawing showing an actuator compensation system for a clutch according to various embodiments of the present invention.

Referring to FIG. 1, an actuator compensation system for a clutch according to various embodiments of the present invention includes a control portion 100, a position detecting portion 110, a motor 200 and an actuator 300.

The control portion 100 operates the motor 200 at a predetermined pressure according to requirement of operation of the clutch 400 so as that the motor operates 200 the clutch 400.

The actuator 300 or the clutch 400 is provided with a pressure sensor 350 which may detect pressure of the actuator 300 applied to the clutch 400 and the pressure sensor 350 outputs the corresponding signal to the control portion 100.

The predetermined pressure may be defined as an operating pressure of the actuator 300 pushing the clutch 400.

And predetermined pressure may be defined as a required pressure which may operate the clutch 400 stably.

During operation of the clutch 400, the position detecting portion 110 detects operating movement of the actuator 300 and the position detecting portion 110 outputs corresponding signal to the control portion 100. And the control portion 100 compensates initial operating position of the actuator 300 if the operating movement of the actuator 300 is changed from a predetermined value.

The predetermined value may be defined as a required distance from the initial operating position of the actuator 300 to a position of the actuator 300 where the clutch 400 may be operated stably.

The motor 200 may be a DC type motor and the motor 200 is operated according to current signal received from the control portion 100. And the motor 200 operates the actuator 300 connected to a shaft of the motor 200.

The actuator 300 includes a lead screw 310 connected with a shaft of the motor 200, a moving body 320 which is gear coupled to the lead screw 310 and moves according to rotation of the lead screw 310, and a rod 330 of which an end is connected with the moving body 320 and the other end is connected with a clutch pedal 410. And the rod 330 pushes the clutch pedal 410 so as to disconnect (release) power.

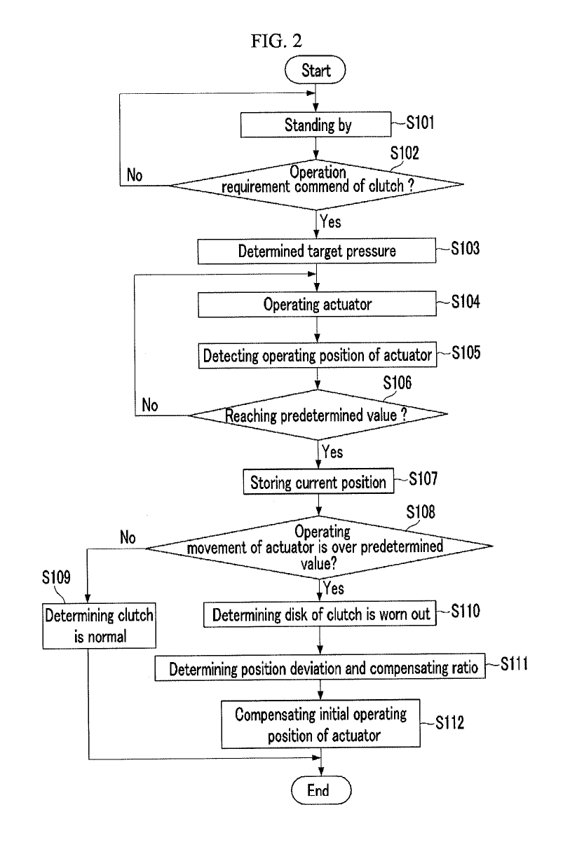

Operation of the actuator compensation system according to various embodiments of the present invention will be described referring to FIG. 2.

The control portion 100 which controls operation of the actuator compensation system that may be applied to a dual clutch transmission system is on standby for operation of the clutch 400 at the step S101, and the control portion 100 determines whether operation requirement commend of the clutch 400 is received from a high rank controller at the step S102.

At the step S102, if the operation requirement commend of the clutch 400 is received from the high rank controller, the control portion 100 determines a target pressure (predetermined pressure) for stroke of the clutch pedal 410 from a predetermined map and outputs current commend at the step S103.

The predetermined map may be data from experiments and the determination of the target pressure (predetermined pressure) is obvious to a person skilled in the art and thus detailed description will be omitted in the specification.

Then the control portion 100 operates the actuator 300 by outputting current commend corresponding the determined target pressure to the motor 200 at the step S104.

The motor 200 rotates the lead screw 310 and the moving body 320 moves. And the rod 330 connected with the moving body 320 pushes the clutch pedal 410 for the clutch 400 to be operated at the step S105.

The control portion 100 detects the operating position of the actuator 300 pushing the clutch pedal 410 at the step S105, and determined whether the pressure of the actuator 300 applied to the clutch 400 reaches the predetermined value (the target pressure) at the step S106.

If the pressure of the actuator 300 applied to the clutch 400 does not reach the predetermined value (the target pressure) at the step S106, it is returned to the step the S104 and the operation of the actuator 300 is repeated.

If the pressure of the actuator 300 applied to the clutch 400 reaches the predetermined value (the target pressure) at the step S106, current position of the actuator 300 is stored at the step S107.

The control portion 100 determines whether the operating movement of the actuator 300 is changed from the predetermined value at the step S108.

If the operating movement of the actuator 300 is not over the predetermined value at the step S108, the control portion 100 determines that the clutch 400 is in normal condition at the step S109.

If the operating movement of the actuator 300 is over the predetermined value at the step S108, the control portion 100 determines that a disk of the clutch 400 is worn out and thus there is an error of the initial operating position of the actuator 300 at the step S110.

Then the control portion 100 determines that position deviation of the actuator 300 is occurred due to abrasion of a disk of the clutch 400 if operating movement of the actuator is strayed from the predetermined value, and determines compensating ratio according to the position deviation at the step S111.

Then the control portion 100 compensates the initial operating position of the actuator 300 by controlling the lead screw 310 of the actuator 300 according to the determined compensating ratio at the step S112.

The compensation ratio may be stored in a predetermined map, and the map may be data from experiments and the determination of the compensation ratio is obvious to a person skilled in the art and thus detailed description will be omitted in the specification.

The motor 200 operating the actuator 300 may be a DC motor or a BLDC motor. Also, identical or similar method may be applied to a DC motor detecting movement of the actuator 300 using a linear position sensor or a hall sensor.

Also, the compensation may be realized by applying movement of the pedal detected by a pedal sensor.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An actuator compensation system for a clutch comprising:
a motor;
an actuator operably connected with the motor and operating a clutch; and
a control portion which operates the motor at a predetermined pressure according to requirement of operation of the clutch so as that the motor operates the clutch, and compensates an initial operating position of the actuator if operating movement of the actuator is changed from a predetermined value.

2. The actuator compensation system of claim 1, wherein the actuator comprises:
a lead screw connected with the motor;
a moving body gear operably coupled to the lead screw; and
a rod having one end connected with the moving body and another end connected with a pedal of the clutch.

3. The actuator compensation system of claim 2, wherein the control portion determines that position deviation of the actuator is occurred due to abrasion of a disk of the clutch if operating movement of the actuator is strayed from the predetermined value, determines compensating ratio, and compensates the initial operating position of the actuator by controlling the lead screw of the actuator according to the determined compensating ratio.

4. A compensation method of an actuator system for a clutch comprising:
determining a target pressure if operating requirement of a clutch is detected and operating an actuator according to the target pressure;
determining whether operating movement of the actuator is strayed from a predetermined value if operating pressure of the actuator reaches the target pressure;
determining error of initial operating position of the actuator if the operating movement of the actuator is strayed from the predetermined value; and
determining compensating ratio according to the detected position deviation of the error and compensates the initial operating position of the actuator by controlling a lead screw of the actuator according to the determined compensating ratio.
